(19) United States
(12) Patent Application Publication
(10) Pub. No.: US 2015/0298072 A1
(43) Pub. Date: Oct. 22, 2015

(54) DEVICE AND METHOD FOR CROSS-FLOW BUBBLE GENERATION

(71) Applicant: Universidad de Sevilla, Sevilla (ES)

(72) Inventors: Javier DÁVILA MARTÍN, Sevilla (ES); Alfredo LUQUE GARCIA, Sevilla (ES)

(21) Appl. No.: 14/418,539

(22) PCT Filed: Jul. 29, 2013
(86) PCT No.: PCT/ES2013/000183

§ 371 Date: Jan. 30, 2015

(30) Foreign Application Priority Data
Jul. 31, 2012 (ES) P201200785

(51) Int. Cl. B01F 3/04; B01F 15/02

(52) U.S. Cl. CPC B01F 3/04262; B01F 15/026

(57) ABSTRACT

Device and method for cross-flow bubble generation comprising a first conduit for the admission of liquids (1) through which an impulsion liquid is supplied at a pressure P_{O} and a second supply conduit for the fluid to be dispersed in the form of drops or bubbles (2), which supplies the fluid to be dispersed at a pressure P_{G} in a pressure chamber (3) and where, between the first conduit for liquid supply (1) and the pressure chamber (3), a diaphragm (4) is placed having injection orifices (8) for interconnecting the fluid to be dispersed with the liquid flowing along the first conduit (1).

The object of the present invention is a device allowing for the generation of bubbles in any type of liquid, with typical sizes ranging from several millimeters to less than 100 microns. For this purpose, the gas to be dispersed is introduced through small orifices or cutouts made in an elastic membrane and poured into a transversal liquid current (cross-flow). To make the drop or bubble generation as efficient as possible, the fraction of energy used in the process to increase the surface of the liquid-gas interface must be maximized in relation with the energy transferred to the system. The device object of this invention is applicable to fields where an efficient generation of small bubbles is an important part of the process, such as the oxygenation and aeration of liquids, liquid-gas transfer processes, separation processes, etc. The main object in most of these applications is maximizing the contact area between the phases.

### PRIOR ART

Existing oxygenation or aeration methods are based upon increasing the gas-liquid contact surface for bringing the concentration of dissolved oxygen closer to the saturation value. Most of the systems in use nowadays (C. E. Boyd 1998, Acuicultural Engineering 18, 9-40) try to fragment a mass of liquid in air, which is afterwards reintroduced into the mass of liquid, or else they produce bubbles which are directly introduced into the liquid. There are some devices producing the breakage of a gas or big bubble stream in the presence of a liquid flow; this is the case of venturis or some pumps which are air impellers or air suckers at the same time; however their yield is low. Its standard aeration efficiency (SAE) is hardly above two kilograms of oxygen per kilowatt-hour consumed.

The most efficient way for bubble generation is the injection of gas inside a liquid co-flow. However, this means that for obtaining large flow rates the placement of hundreds or thousands of needles inside the stream would be required. It therefore seems more interesting to carry out the injection of the gas by means of several of orifices made in the wall of the main conduct, in such a way that at the outlet thereof the transversal liquid flow produces a strong drag over the gas coming out from the orifices. This cross-flow layout can generate diverse regimens or modes (S. E. Forrester y C. D. Rielly 1998, Chemical Engineering Science 53, pag. 1517-1527) according to the geometry of the device and the injected flow rates of gas and liquid. For gas-liquid transfer applications, the most interesting mode is the one called bubbling mode, which takes place with low gas flow rates and which shows a regular production of approximately spherical bubbles of uniform size near the injection orifice. The main drawback of this operation mode is that, for the usual geometrical configurations, the ratio between the injected gas flow rate and the impeller liquid flow rate is very low. When the gas flow rate is high, a continuous jet, anchored to the orifice outlet, is formed. This jet is later broken into irregular fragments in a chaotic way. This is known as the jet-mode.

During the last decades, a large number of patents regarding bubble generation based on cross-flow procedures have been published (U.S. Pat. No. 3,489,396, U.S. Pat. No. 4,708,829 and PCT/ES2007/000089, among many others). The main drawback of these devices is that they clog easily when working with liquids or gases charged with solid particles, unless conduits and orifices are big enough; in this case, the aeration efficiency is considerably reduced. To overcome this problem, in many waste water treatment processes membrane diffusers are used (see, for example patents, with reference numbers US2010133709, CN101397169 and DE4211648), in which air or oxygen injection is performed through small orifices made in a moving membrane (diaphragm) whose orifices close when there is a failure in the supply of gas. However, the size of the bubbles produced with these devices is significantly bigger than that of the bubbles produced in cross-flow instruments. Inventions related to cross-flow devices based on membranes have been previously published, such as U.S. Pat. No. 3,545,731; nevertheless, these are devices in which coalescence phenomena are very likely, the final result being the production of large bubbles.

The average equivalent diameter of the bubbles generated at the outlet of the orifices in the bubbling mode is approximately:

d_{eq}≈C(Q_{g}/uₗ)^{a},

where Q_{g} is the gas flow rate injected through the orifice and uₗ the speed of the liquid surrounding the jet. C and a are two experimental coefficients. Values of exponent a reported in the bibliography are between ⅓ and ½. (P. F. Wace, M. S. Morrell y J. Woodrow 1987, Chemical Engineering Communications 62, pag. 93-106). Thus, the bubble diameter does not depend on the passage area of the liquid flow; for this reason, to minimize the consumption of the liquid impulsion and then increase the efficiency of these devices, the transversal area of the main conduit in the injection section should be as small as possible.

### DESCRIPTION OF THE INVENTION

The technical problem solved with the present invention is to enable the formation of small drops and bubbles by the generation of zones of intense shear in the flow. From a conceptual point of view, the present invention has as its essential advantage that small bubbles are formed directly from the anchored meniscus, instead of from jets or bubbles generated with any other procedure; this is a key aspect for maximizing the energy efficiency. In connection with the bubble generation systems through membranes or ceramic diffusers, the invention is advantageous in that the liquid flow driven over the orifices reduces substantially the size of the bubbles. With respect to other cross-flow devices, it is advantageous in that the moving membrane or diaphragm avoids obstruction caused by small particles.

As stated above, the object of the present invention is a device for drop and bubble generation inside a liquid flow. Among the number of procedures commonly used for small drops and bubbles generation, this invention uses the injection through orifices in a transversal flow resulting in the formation of drops or bubbles that are typically within the millimeter or micrometer range.

When a gas (or a miscible liquid) is injected in a transversal liquid flow, a meniscus appears that eventually detaches from the orifice. In this sense, the proposed procedure is similar to those based on the Venturi effect in which, additionally, part of the kinetic energy provided to the flow through a divergent nozzle located adjacent to the injection zone is recovered. However, the cross-flow device disclosed herein advantageously shows a much lower energy consumption due to fact that the liquid flow in the main stream is minimized, and the bubbles detached from the orifices are substantially smaller. On the other hand, the injection through a diaphragm avoids the accumulation of solid particles inside the device, thus allowing for working with dirty fluids and high flow rates.

By means of this system, extremely small drops and bubbles can be produced, the only main limitations being the production costs of the devices. As an additional advantage, a strong agitation of the mixture takes place, the result being a substantial increase in the transfer between phases. The flow rate of the impulsion liquid and the fluid to be dispersed can be controlled through regulation valves.

In the case of oxygenation or aeration of water, the standard aeration efficiency (SAE) may reach values above 10 kg of dissolved oxygen per kilowatt-hour. This may allow, among other applications, for an efficient dissolution of gases in liquids or, analogously, a significant increase of the reaction rate in liquid-gas or liquid-liquid chemical reactors.

More specifically, in a first aspect of the invention, the device for drop or bubble generation in a liquid comprises a first conduit for the admission of liquids, through which the impulsion liquid is supplied at pressure P_{O}, and a second gas supply conduit through which the gas to be dispersed is supplied at pressure P_{G} into a pressure chamber, and where between the first liquid supply conduit and the pressure chamber a diaphragm is placed, said diaphragm having injection orifices interconnecting the fluid to be dispersed with the liquid flowing through the first conduit, characterized by comprising a passage section between injection orifices (8), this is, between the membrane and the rigid wall (10) in the plane of the injection orifices, where the area of the transversal section in said injection zone is smaller than the result of multiplying 25 mm² by the number of injection orifices; all this in such a way that the coalescence between bubbles is avoided.

In a particular embodiment, there are flow separation means consisting of elongate elements (9) or plain walls essentially perpendicular to the rigid wall (10) in such a way that the liquid flows along parallel longitudinal channels against whose rigid elongate elements the diaphragm abuts, starting from a value corresponding to the pressure difference between the pressure at the entrance of the fluid to be dispersed and the discharge pressure of the device P_{G}−P_{S}, when the diaphragm is deformed towards the centre of the first conduit.

In a particular embodiment, the range of the area in the transversal section in the injection zone of at least one of the longitudinal parallel channels where the flow separates, is between 0.001 mm² and 5 mm², which are in practice the most useful values because bubbles with sizes between some millimeters and 100 microns can be generated, and at the same time they are not so small as to have clogging problems in the flow circulation.

The elongate rigid elements on which the diaphragm rests, which separates the first liquid supply conduit and the pressure chamber containing the flow to be dispersed, are attached to a wall of the first conduit for liquid admission, this wall being located opposite to the diaphragm.

In a second particular embodiment, said flow separation means are a number of a plurality of grooves previously formed in the diaphragm (4) in the longitudinal (streamwise) direction of the liquid flow, where those grooves divide the liquid flow in several parallel conduits, touching the rigid wall opposite the diaphragm and in whose interior the orifices for gas injection are located, starting from a value corresponding to the difference between the pressure at the entrance of the fluid to be dispersed and the discharge pressure of the device P_{G}−P_{S}, when the diaphragm is deformed towards the centre of the first conduit.

In a particular embodiment, the geometry in the injection zone is defined by the angle formed between the straight line joining the centers of each pair of injection orifices and the trajectory of the bubbles that come out from any of those orifices; and where additionally said angle is greater than 10°. The bubble lines do not come out perpendicularly to the diaphragm but they follow trajectories which are essentially parallel to it.

In a second aspect of the invention, the method for the generation of cross-flow bubbles of the type implemented in the described device which comprises the stages of supplying an impulsion liquid at a pressure P_{O} through a first liquid admission conduit and a second stage of introducing the gas to be dispersed at a pressure P_{G} into a pressure chamber through a second gas supply conduit through a diaphragm having injection orifices interconnecting the fluid to be dispersed with the liquid flowing through the first conduit, characterized by comprising the injection through these injection orifices (8) across a transversal section with an area smaller than the result of multiplying 25 mm² by the number of injection orifices (8), avoiding coalescence between bubbles.

Along the description and claims, the word “comprises” and its variants do not pretend to exclude other technical characteristics, additives, components or steps. For those of skill in the art, other objects, advantages and characteristics of the invention will follow in part from the description and in part from the practice of the invention. The following examples and drawings are given for illustrative purposes and they should not be interpreted to limit the present invention. In addition, the present invention covers every possible combination of particular and preferred embodiments disclosed herein.

### BRIEF DESCRIPTION OF THE DRAWINGS

Next, a number of drawings intended to provide for a better understanding of the invention and which are specifically related to a non-limiting exemplary embodiment of said invention are disclosed.

FIG. 1.—Shows a section view of the bubble generator device which is the object of the invention, more specifically it corresponds to the average section of the device in the longitudinal (streamwise) direction of the flow.

FIG. 2.—Shows a second section view of the device of FIG. 1 which specifically corresponds to the transversal (spanwise) section of the flow in the zone where the orifices for the gas injection are located.

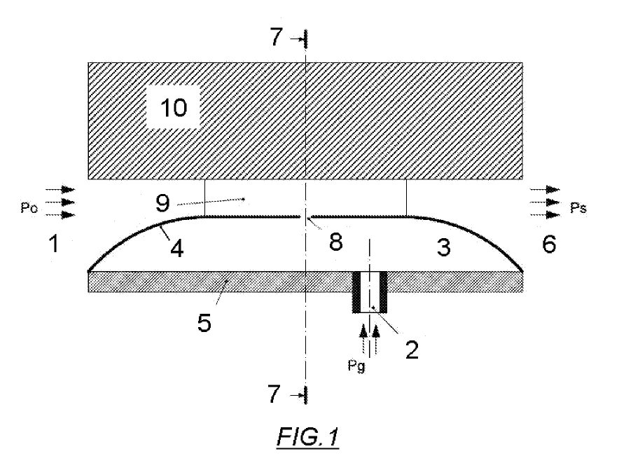

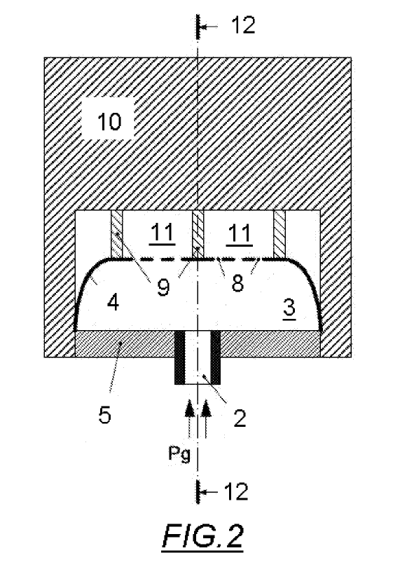

The reference characters used in the figures are the following:
1. Inlet for liquid admission.
2. Inlet for gas admission.
3. Pressure chamber for the gas to be dispersed in the liquid.
4. Elastic membrane (diaphragm).
5. Rigid wall to which the diaphragm is joined to avoid gas leak.
6. Outlet of the gas dispersed in the liquid.
7. Section where the orifices for gas injection are located. Said section corresponds to FIG. 2.
8. Injection orifices in the membrane through which the gas is injected along a line perpendicular to the direction of the fluid flow.
9. Rigid elongated elements in the longitudinal (streamwise) direction of the liquid flow that determine the position of the diaphragm.
10. Solid wall closing the liquid conduit.
11. Narrow channels dividing the liquid conduit.
12. Average section corresponding to the image of FIG. 1.
P_{O}=impulsion pressure of the liquid.
P_{G}=pressure inside the gas chamber.
P_{S}=pressure at device exit.

### DETAILED DESCRIPTION AND EXAMPLE OF A PRACTICAL EMBODIMENT OF THE INVENTION

The invention assumes the fact that the formation of a meniscus anchored at the outlet of an orifice is consequence of the balance between aerodynamic resistance forces, surface tension and inertia, since the effect of gravity is usually negligible in this process. Depending on the geometric configuration and the velocity of the two fluids, the meniscus breaks up and small fragments in the form of drops or bubbles detach. A parametric range is used (set of special values related to the properties of the fluids, size of the orifices, flow rates, etc.) such that, fragments of a typical diameter of some hundreds microns are produced when the meniscus breaks up, so that the energy efficiency is maximum, in case that is the goal, being although other cases are possible in which the goal is to reach the minimum possible size at the expense of decreasing efficiency.

In order to achieve a normal operation of the bubbles or drops generator, the flow of liquid and the flow of gas to be dispersed kept constant. The relationship between the supply pressure in the impulsion liquid, P_{O}, and the pressure at the injection section, P_{I}, is

$${P}_{0} = {P}_{I} + \frac{1}{2} {ρ}_{l} {u}_{l}^{2} ( 1 - \frac{{A}_{I}^{2}}{{A}_{O}^{2}} ) ,$$

where A_{I} y A_{O} are the passage areas in the zones of gas injection and liquid impulsion, ρₗ y uₗ are respectively, the density and velocity of the liquid, and it has been assumed that this transition of areas is smooth in order to avoid losses in the stagnation pressure (equation of Bernoulli). Moreover, in the gas supply a pressure P_{G} must be applied to overcome the head loss caused by the orifices:

$${P}_{G} = {P}_{I} + \frac{{k}_{g}}{2} {ρ}_{g} {u}_{g}^{2} ,$$

where k_{g} is the head loss constant of the orifice (Idelchik, Handbook of Hydraulic Resistence, Hemisphere Pub. Corp., 1986), ρ_{g} the gas density and u_{g} the gas velocity at the orifice. The pressure P_{I} is related to the discharge pressure, P_{S}, through:

$${P}_{I} = {P}_{S} + \frac{{k}_{m}}{2} {ρ}_{m} {u}_{m}^{2} ,$$

where ρₘ y uₘ are the density and the velocity of the liquid-gas mixture and kₘ is the head loss constant at the outlet. These equations link the supply pressure of the liquid or gas to be dispersed (P_{G}) with that of the discharge zone (P_{S}) through the head losses.

In this process, energy consumption are related with the impulsion of both fluids (which is used for increasing the surface tension, the kinetic energy and in viscose dissipation) and therefore it can be calculated through the expression:

\dot{W}=\dot{W}ₗ+\dot{W}_{g}=(P_{O}−P_{S})+Q_{q}(P_{G}−Pₐ),

where Qₗ is the liquid flow rate providing the main stream and Q_{g} is the dispersed gas or liquid flow rate. In this expression, the liquid is considered to be recirculated (using any pumping system) from the pressure P_{S} and that the gas is compressed from the atmospheric pressure, Pₐ. The previous relationships show that the energy consumption of the gas or liquid to be dispersed is determined by the pressure at the discharge zone (P_{S}) and by the head loss in the injection, while the consumption related to the liquid impulsion is connected with the geometry and velocity in the main conduit.

For applications related to oxygenation or dissolution of gasses in liquids, the standard aeration efficiency (SAE) in a kg of dissolved oxygen per kWh can be obtained from:

$$SAE = \frac{{α}_{g} {Q}_{g} {ρ}_{g} {Y}_{{O}_{2}}}{{\dot{W}}_{l} + {\dot{W}}_{g}}$$

where Q_{g} is expressed in m³/h, ρ_{g} in kg/m³ and the power in kW. α_{g} is the fraction of O₂ dissolved in the liquid with respect to the injected oxygen and Y_{O2} is the volumetric fraction of oxygen in the injected gas (0.21 for air in normal conditions). The value of α_{g} depends only on the size and frequency of the generated bubbles. Therefore, to maximize the energy efficiency, the cost of impulsion has to be reduced without increasing too much the average size of the resulting bubbles, so that the value of α_{g} is high.

Since the size of the bubbles detached from the injection orifices depends on the liquid velocity but not on the liquid flow rate, it is convenient to maintain a high liquid velocity and reduce at the same time the liquid flow rate, which can be achieved reducing as much as possible the passage area of the conduit in the zone of injection of the fluid to be dispersed. The velocity at the dispersion zone should not be very high, as this would mean important kinetic energy losses downstream the device.

The objective of the present device is to obtain smaller sizes in comparison with those achieved with the existing membrane diffusers, which produce bubbles with an average typical size of some millimeters. For this purpose, the injection is made through orifices that discharge in a transversal liquid flow (cross-flow); but to increase the efficiency even more, the transversal section in the injection zone has to be as small as possible. Any bubble with a diameter of less than 3 mm would have enough space in the main conduit if there was no interference between bubble trajectories and the area related to its injection orifice was 25 mm². Therefore, in the device object of this invention, the passage area in the average transversal section in the injection zone is smaller than the result of multiplying 25 mm² by the number of injection orifices. If the injection is made through a diaphragm, said passage section of liquid is reduced when the pressure inside the chamber containing the gas or liquid to be dispersed increases, this contributing to improve the efficiency of the device. The maximum value of the average transversal section that results from multiplying 25 mm² by the number of orifices is measured when the pressure in the chamber containing the gas or liquid to be dispersed is stable or when the diaphragm rests on the opposite wall.

To avoid coalescence phenomena between the drops or bubbles generated inside the device, it is essential that they do not interfere in their movement towards the outlet. The dispersion of the bubbles inside de device is very low; thus, if the angle formed by the straight line joining two orifices and the direction of the bubbles that coming out from those orifices is above 10 grades, the probability of coalescence is negligible.

When the gas (or liquid to be dispersed) is injected through a diaphragm formed by an elastic membrane, the average passage section in the zone of injection depends on the gas supply pressure. To control the passage area in this injection zone, solid elements, elongated in the longitudinal (streamwise) direction of the flow, can be placed in order to divide the liquid conduit in several parallel conduits, such that the diaphragm abuts on the opposite wall starting from a value corresponding to the difference between the pressure at the inlet of the fluid to be dispersed and the discharge pressure of the device. These separators can be joined to the wall opposite to the diaphragm, be part of it, or even not be joined to any of the lateral walls of the liquid conduit.

### Example of a Practical Embodiment of the Invention

A practical embodiment of the invention is shown in the following figures, where the device requires the supply of a flow rate for the impulsion liquid and a flow rate for the gas or liquid to be dispersed. Both flow rates should be appropriate so that the system is within the parametric range of interest to reach the specifications of a concrete application. The number of orifices for the injection the dispersing fluid and the transversal section of the main conduit in the injection zone will be increased if the fluid velocity in this zone is very high for the required flow rates and therefore the efficiency is very low as a consequence of excessive pressure upstream the conduits. Moreover, several parallel main conduits could be used to supply the impulsion liquid, such that in these conduits the gas or liquid to be dispersed is injected through multiple orifices.

A larger flow rate of impulsion liquid and of gas or liquid to be dispersed can be supplied by any means in specific applications (oxygenation, gas-liquid or liquid-liquid chemical reactors, etc.) because this does not interfere with the operation of the device. Therefore, any method for supplying the impulsion liquid and the gas or liquid to be dispersed (compressors, volumetric pumps, compressed gas bottles, etc.) can be used.

The flow rate of the fluid to be dispersed should be distributed as homogeneously as possible between the different orifices; this may require a minimum size for the injection orifices or any other method capable of homogeneously distributing the flow rate among the different supply points. The atomizer may be manufactured in multiple materials (metal, plastic, ceramic, glass), mainly depending on the specific application of the device.

FIGS. 1 and 2 show the scheme of a prototype in which the impulsion liquid, at Po pressure, is introduced in the conduit through the liquid inlet (1) and the gas to be dispersed, at P_{G} pressure, is introduced through the gas supply conduit (2) into a pressure chamber (3). Said pressure chamber is limited by the conduit (2), an elastic membrane or diaphragm (4) and a rigid wall (5) to which the diaphragm is joined to avoid gas leaks. In this prototype, gas supply pressures from 5 mbar to 2 bar above the pressure P_{S} of the discharge point (6) have been used. The gas supply pressure should be always slightly higher than that of the liquid in the injection section (7), where the cuts (8) made in the membrane are located, depending on the head loss of the gas injection system, to assure a certain ratio between liquid/gas flow rates.

As showed in FIG. 2, to assure a minimum passage section for the liquid in this prototype solid elements (9) joined to the upper wall (10) and elongated in the longitudinal (streamwise) direction of the liquid flow are provided, such that the water flows along narrow longitudinal channels (11). This figure also shows the position of section (12) which corresponds to the image of FIG. 1.

The rest of dimensions in the prototype do not affect in any case to the generation of bubbles, provided that the pressure chamber is big enough compared with the injection orifices. It has not been accurately described how the liquid conduit is closed at the side ends, where the diaphragm has to be fixed against the opposite wall, because it is not relevant for the operation of the device. Similarly, it is neither relevant how the chamber of the fluid to be dispersed is closed.

1. Device for drops and bubbles generation in a liquid comprising a first conduit for the admission of liquids through which the impulsion liquid is supplied at a pressure P_{O} and a second supply conduit for the fluid to be dispersed in the form of drops or bubbles thorough which the fluid to be dispersed is supplied at a pressure P_{G} into a pressure chamber; and where between the first liquid supply conduit and the pressure chamber, a diaphragm is placed having injection orifices allowing for the interconnection between the fluid to be dispersed and the liquid flowing along the first conduit; a passage section between the membrane and the rigid wall in the plane of the injection orifices, where the area of the transversal section in said injection zone is smaller than the result of multiplying 25 mm² by the number of injection orifices; all this in such a way that the coalescence among bubbles is avoided.

2. Device according to claim 1 where the geometry in the injection zone is defined by the angle formed by the straight line joining the centers of each pair of injection orifices and the orthogonal projection of the trajectory of the bubbles coming out from any of those orifices, said angle being greater than 10° in such a way that the bubble trajectories do not come out perpendicular to the diaphragm but describe trajectories essentially parallel to it.

3. Device according to claim 1 comprising flow separation means along the longitudinal (streamwise) direction of the flow starting from a value corresponding to the difference between the pressure at the inlet of the fluid to be dispersed and the discharge pressure of the device P_{G}−P_{S}; where the range of the area of the transversal section at the injection zone of at least one of the parallel longitudinal channels in which the fluid is divided is between 0.001 mm² and 5 mm², which are the most useful values because bubbles between several mm and 100 microns can be generated and at the same time they are not small enough so as to have clogging problems in the flow circulation.

4. Device according to claim 1 comprising flow separation means along the longitudinal (streamwise) direction of the flow starting from a value corresponding to the difference between the pressure at the inlet of the fluid to be dispersed and the discharge pressure of the device P_{G}−P_{S}; and where the means consist of elongated elements or plane walls essentially perpendicular to the rigid wall such that the liquid circulates along longitudinal parallel channels against whose elongated rigid elements the diaphragm rests starting from a value corresponding to the difference between the pressure at the entrance of the fluid to be dispersed and the discharge pressure in the device P_{G}−P_{S}, when the diaphragm is deformed towards the center of the first conduit.

5. Device according to claim 4 where the elongated solid elements on which the diaphragm abuts, which also separates the first liquid supply conduit and the pressure chamber containing the fluid to be dispersed, are joined to a wall of the first inlet conduit for liquids, this wall being located opposite the diaphragm.

6. Device according to claim 1 comprising flow separation means along the longitudinal (streamwise) direction of the flow starting from a value corresponding to the difference between the pressure at the inlet of the fluid to be dispersed and the discharge pressure of the device P_{G}−P_{S}; and where the means consist of a number of grooves previously formed in the diaphragm in the longitudinal (streamwise) direction of the liquid flow, where those grooves divide the liquid stream in several parallel conduits, touching the rigid wall opposite the diaphragm and in whose interior the orifices for gas injection are located, starting from a value corresponding to the difference between the pressure at the entrance of the fluid to be dispersed and the discharge pressure of the device P_{G}−P_{S}, when the diaphragm is deformed towards the centre of the first conduit.

7. Method for cross-flow generation of bubbles of the type implemented in the device of claim 1 comprising
supplying an impulsion liquid at a pressure P_{O} through a first conduit for liquid admission;
introducing the gas to be dispersed at a pressure P_{G} in a pressure chamber through a second gas supply conduit through a diaphragm having injection orifices for interconnecting the fluid to be dispersed with the liquid flowing through the first conduit
wherein the injection comprises through these injection orifices across a transversal section with an area smaller than the result of multiplying 25 mm² by the number of injection orifices, avoiding coalescence between bubbles.

8. Method according to claim 7, further comprising flow separating along the longitudinal (streamwise) direction of the flow starting from the value corresponding to the difference in the pressure at the inlet of the fluid to be dispersed and the discharge pressure of the device P_{G}−P_{S}; where the flow separation is made by elongated rigid elements in the longitudinal (streamwise) direction of the fluid movement such that the liquid flows along parallel longitudinal channels against whose elongated rigid elements the diaphragm abuts starting from a value corresponding to the difference between the pressure at the inlet of the fluid to be dispersed and the discharge pressure of the device P_{G}−P_{S}, when the diaphragm is deformed towards the centre of the first conduit.

9. Method according to claim 7 further comprising flow separating along the longitudinal (streamwise) direction of the flow starting from a value corresponding to the difference in the pressure at the inlet of the fluid to be dispersed and the discharge pressure of the device P_{G}−P_{S}; and where the separation of the flow is made by a number of grooves made in the diaphragm in the longitudinal (streamwise) direction of the liquids flow, where said grooves divide the liquid stream in several parallel conduits starting from a value corresponding to the difference between the pressure at the entrance of the fluid to be dispersed and the discharge pressure of the device P_{G}−P_{S}, when the diaphragm is deformed towards the centre of the first conduit.
